(19) United States
(12) Patent Application Publication
(10) Pub. No.: US 2018/0084755 A1
(43) Pub. Date: Mar. 29, 2018

(54) Food Bowl

(71) Applicant: Ogilvy & Mather Düsseldorf GmbH, Düsseldorf (DE)

(72) Inventor: Markus Hirschl, Köln (DE)

(21) Appl. No.: 15/569,032

(22) PCT Filed: Apr. 22, 2016
(86) PCT No.: PCT/EP2016/059003

§ 371 Date: Oct. 24, 2017

(30) Foreign Application Priority Data
Apr. 24, 2015 (DE) 102015005248.9

(51) Int. Cl. A01K 5/01; A01K 11/00; A01K 29/00; G06K 7/10

(52) U.S. Cl. CPC A01K 5/0114; G06K 7/10366; A01K 29/005; A01K 11/006

(57) ABSTRACT

The invention relates to a food bowl for a domestic animal, in particular for a dog, characterized by an electronic balance which has a data output and is designed to measure the weight in the bowl and to transmit said weight to the data output as an electronic weight signal.

The present invention relates to a food bowl for a domestic animal, in particular for a dog.

Domestic animals such as cats and dogs are part of our culture and society. Great care is taken to monitor their health and wellbeing. Research in veterinary medicine and ecotrophology has led to a wide range of different suitable foods and information on the need to ensure daily movement of domestic animals for physiological reasons.

Over time, finding an appropriate solution for individual animals from this wide range of information has become a widespread problem.

The object of the present invention is to create a device that makes it easier to feed a domestic animal, in particular a dog, appropriately.

This object is achieved by a device with the features specified in claim 1. Preferred embodiments of the invention are specified in the dependent claims.

According to the invention, a food bowl for a domestic animal, in particular for a dog, is characterised by an electronic balance which has a data output and is designed to measure the weight in the bowl and to transmit said weight to the data output as an electronic weight signal. This forms the basis for “balanced” nutrition, literally speaking—and for a range of systems as preferred embodiments of the invention, which also simplify this aim, especially by achieving this in different ways.

In other words, the food bowl may, for example, comprise an electronic display device which is connected to the data output of the balance by means of a data connection, and is designed to change its display as a function of the weight signal. The display device may therefore, for example, simply show the weight as a figure, which makes it possible to measure out the portion of a daily food requirement from a table on the food pack, for example. Such tables are known to differentiate according to the weight of the animals in question and as a result it is easy to work out the respective portion weight “in one's head” if the individual animal is accustomed to having its daily food requirements in three daily portions, for example. If the animal does not eat the entire portion, the weight of the remaining food can be read on the possible display according to the invention and taken into account in the daily balance total—especially if the uneaten residue is not left out for later consumption, because the food is perishable, for example.

The fact that the invention relates to an electronic balance makes it possible for the food bowl according to the invention to comprise a data output in addition to (or instead of) the display, said data output in particular being in the form of a WLAN module with a WLAN aerial (but also in the form of a Bluetooth module and/or at least one cable interface, such as a USB connection, for example). For various purposes, some of which are explained by way of example below, this data output may be connected by a data connection to an electronic computer and/or an internet router or may be designed for such a data connection.

Thus, the computer (for example in the form of a chip specialising in the respective functions with correspondingly programmed (and possible also programmable) software and wiring and operating hardware) and/or the router may be integrated directly in the food bowl and/or they may be separate devices. Thus, the computer may be a portable PC, in particular, or in other words especially a notebook, tablet or smartphone according to current standards. Suitable smaller programs, so-called apps, are in widespread use, especially for the latter items. Software in this format to support the functions according to the invention and possible functions according to the invention is also a preferred option.

Thus, the computer for the food bowl according to the invention may be designed to add up the weight signals and/or to generate a trigger signal on reaching a programmable limit value.

The trigger signal may, for example, initiate a warning signal (for example an LED and/or a sound on the bowl and/or in particular on a separate computer) when a programmed filling quantity and/or daily ration is reached. To this end the computer is able to process and/or save the weight signals, in particular also in a time-correlated manner, in order to establish, in connection with the daily food ration, for example, whether the next day may possibly already have started if the limit value is exceeded and whether the additional food quantity therefore possibly belongs to the next day's ration.

However, another preferred function of the trigger signal according to the invention is that it places an order for a new supply of food (in particular over the internet via an online shop) when the cumulative food weight indicates that the existing food supply is running out.

The food bowl also comprises an RFID sensor (a Bluetooth module may also be suited to this purpose according to the invention, for example) for this function, said sensor being designed to initiate specific computer operations by detecting a specific RFID tag—in this case specifically on a food sack. The computer's totalising memory may initially be set to zero by a corresponding program, for example, before a new food pack is opened. If food is poured into the bowl according to the invention from this pack with the RFID tag, the RFID sensor “detects” this pack, weighs the amount of food that has been poured out and saves this figure in the totalising memory: the pack is emptied by this amount. If something else is poured into the animal's bowl in the meantime, the balance according to the invention also weighs this item (and is able to display this weight), but because the RFID tag on the pack is missing, this weight is not added to the totalising memory (or at any rate not to the totalising memory used to assess the pack filling level, but to at least one memory recording the animal's eating behaviour). Only when food is again poured into the bowl according to the invention from this pack with the RFID tag does the RFID sensor detect this pack again, weigh the amount of food that has been poured out and add this figure to the totalising memory. If a limit value (which can potentially be set by the user by means of a corresponding program) in the totalising memory is exceeded, this means that the remaining food in the pack is less than its initial contents (the pack contents on purchase, for example) minus the amount added to the totalising memory, and the computer (which is potentially programmed correspondingly according to the invention) is able to initiate an order for a new food pack and delivery of said pack (automatically, even without any further action on the part of the user). To this end, the bowl may be connected to the computer by the above-mentioned data output or by a second data output (in WLAN, Bluetooth and/or USB format, for example) via a data connection, or it may be possible to establish such a connection.

However, the preferred RFID sensor according to the invention on the food bowl may not only initiate measurement and/or totalising (in the described manner, for example), but may also be used to program the limit value. If specific different tags are programmed to specific different pack food weights in the program in the computer, the program may set a limit value adjusted to this pack weight for the purpose of placing an order when it first detects an RFID tag.

Another function of the food bowl according to the invention with an electronic balance (alternatively or in addition to the embodiments of the invention described above, such as, for example, the “automatic order function”) is the ability to consider the animal's activity when feeding with the aid of the bowl according to the invention. To this end, the bowl in turn comprises a programmable EDP device (as already described above in the form of an integral and/or separate computer), but this time more preferably with a wireless data receiving device, in particular Bluetooth. These are designed to receive data from a collar for a domestic animal, in particular for a dog (or an attachment that can be attached to a standard collar). The collar accordingly has a wireless data transmitting device, in particular complying with Bluetooth standards, and an “activity sensor”. Such an assembly includes sensors such as a gyroscope and/or an accelerometer, for example, and is designed to generate an electronic signal as a function of accelerations picked up by said sensors, and to save this “activity signal” in an activity data memory (in this case preferably also incorporated in the collar), and to do this in a time-correlated manner in particular, and in particular also to accumulate or totalise said data (once again in a time-correlated manner, in particular). Such a sensor may be designed to measure (translational and/or rotational) accelerations in a plurality of or individual directions (in particular the three Cartesian spatial directions), each potentially also being differentiated from the other.

The EDP device is therefore designed to receive electronic activity data from the activity data memory from the collar. The EDP device is thus initially able to change a display as a function of the activity data (for example, just as smartphones evaluate data in a statistical and/or time-related manner and display the processed data (graphically, for example) (on the smartphone display, for example)). However, the EDP device can also (alternatively or in addition) be designed to calculate a required food portion weight (on a daily basis, for example) based on the activity data and programmed parameters (in particular relating to the domestic animal, such as, for example, the type of animal, breed, weight, gender or age). As described in the introduction, there is a great deal of information about the relationship between food requirements and previous food consumption as a function of activity, and this relationship (less food is required for less activity in qualitative terms) can be taken into account in the calculation by different quantities. This required food portion weight can then be transmitted as an electronic “requirement signal” to the display device (as may possibly be provided according to the invention as explained initially above) on the bowl (and/or for display on the EDP device, for example, i.e. on its display in the form of app) by a data connection, and preferably wirelessly (for example W-LAN or Bluetooth) in the case of a separate EDP device (a smartphone, for example).

The display device may accordingly be designed to also change its display as a function of the requirement signal. The display device may thus preferably not (or not only) display the weight in the bowl as a figure, but (also) as a proportion of the calculated required food portion weight. In order to do this in a clear and graphical manner, for example, it is sufficient to have a row of (for example) two-colour LEDs (or a corresponding bar chart) which first displays the calculated required food weight for the animal for this portion in one colour (required food portion weight)—either as a “bar” length which is proportional to the calculated weight or always with the same length as “100%”—and then displays the weight of the food portion poured into the bowl in a second colour (measured by the integral balance in the bowl according to the invention) in relation to the first weight. However, the display device may also be designed to display the weight in the bowl as a proportion of just one portion weight that can be poured in directly—for example, if the bowl according to the invention does not allow the required food portion weight to be calculated, but the described clear relative bar chart display still needs to be used as a 100% value for a single serving of the same portion quantity each time, for example (according to a table on the pack based on type of animal, breed, weight, gender or age, for example).

The bowl according to the invention may be used with such a collar (and/or collar attachment) and/or with the possible separate computer, as mentioned previously (for example, a tablet or smartphone), to form a coordinated system as an embodiment of the invention. In this case the “bowl” may also be an electronic balance according to the invention which is designed to be placed beneath a traditional bowl, said balance having a data output and being designed to measure the weight in a traditional bowl and transmit said weight to the data output as an electronic weight signal.

The RFID sensor described above on the bowl may have an additional function according to the invention (alternatively or additionally). To this end, an EDP device (such as the above-mentioned device, a smartphone, for example, or in particular the above-mentioned EDP device with the described functions and features) may in the first instance be connected to the data output of the balance by means of a data connection and may be designed to calculate food consumption, and to save this figure in a consumption signal data memory as an electronic consumption signal based on the weight signal, in particular the change in said weight signal, i.e. specifically in a time-correlated manner. The EDP device may evaluate this data by statistical and/or time-related means, for example, and then display the data on the smartphone display (processed in graphical form, for example) when the user makes a corresponding query by using an app. The RFID sensor is in particular designed to calculate food consumption and/or to initiate a sequence in which the consumption signal is saved by detecting a specific RFID tag on the collar (or collar attachment)—and to thus prevent the EDP device processing the food consumed by a different animal than the animal wearing the collar, if the other animal happens to eat from the same bowl, for example.

Similarly, the possible RFID sensor in the bowl according to the invention may also initiate reception of activity data from the collar and/or display and/or a change in the display (by means of a signal transmitted to the EDP device by means of a data connection in each case).

Additional advantages, embodiments and details of the invention are described below in the description of possible embodiments with reference to the attached figures:

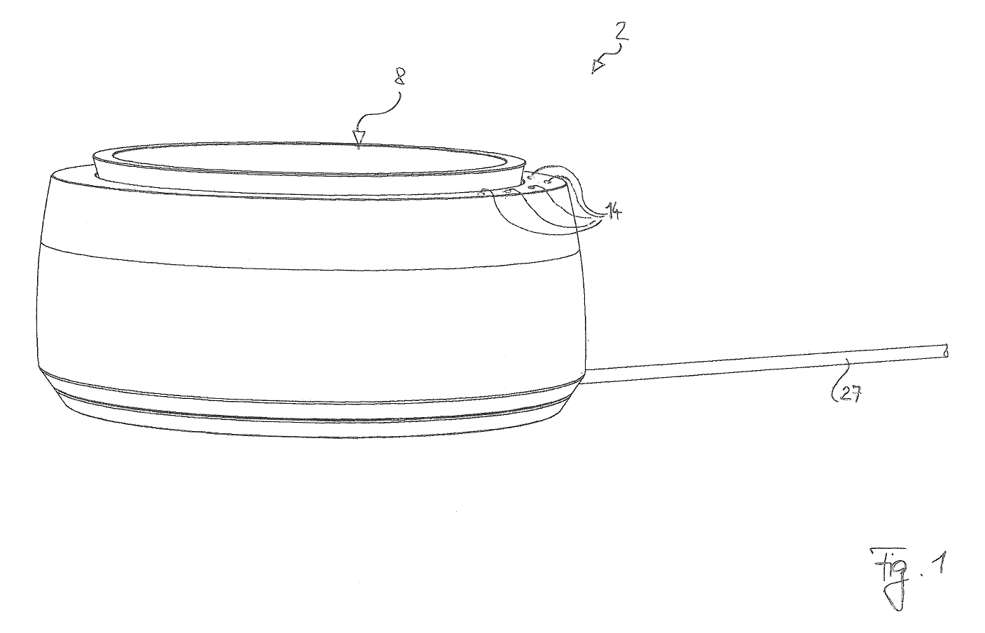

FIG. 1 shows a spatial view of a food bowl according to the invention.

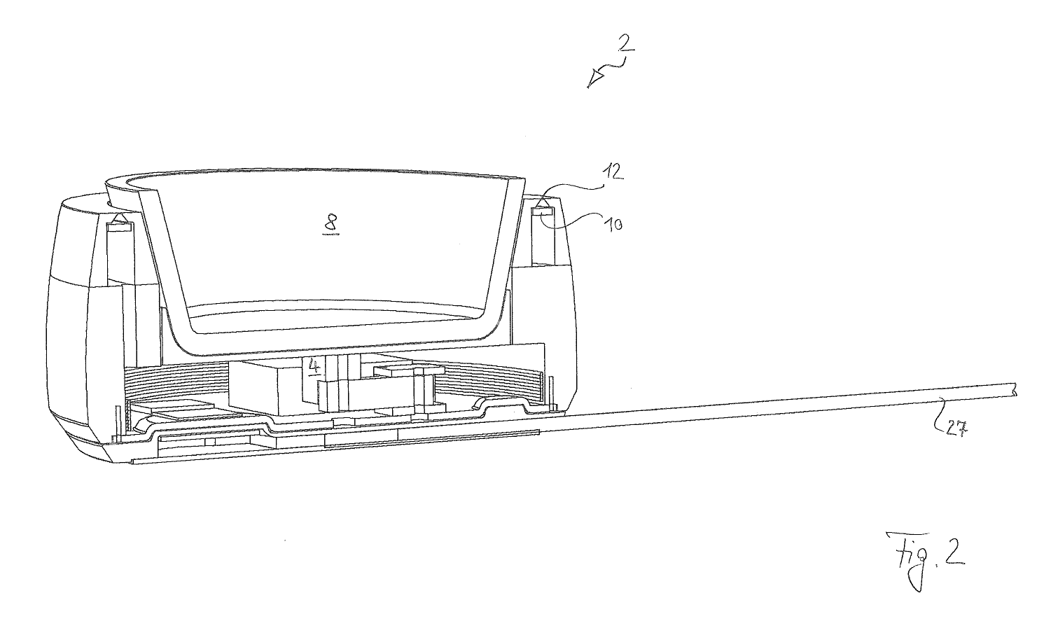

FIG. 2 shows a section through a spatial view of the food bowl according to the invention from FIG. 1.

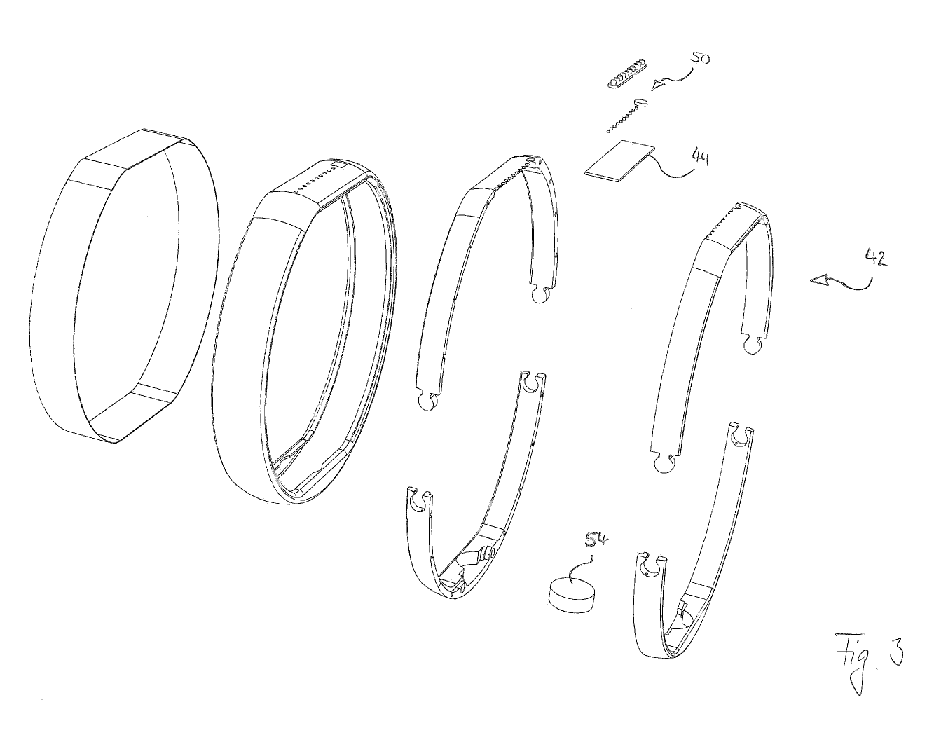

FIG. 3 shows an exploded spatial view of a collar according to the invention, and

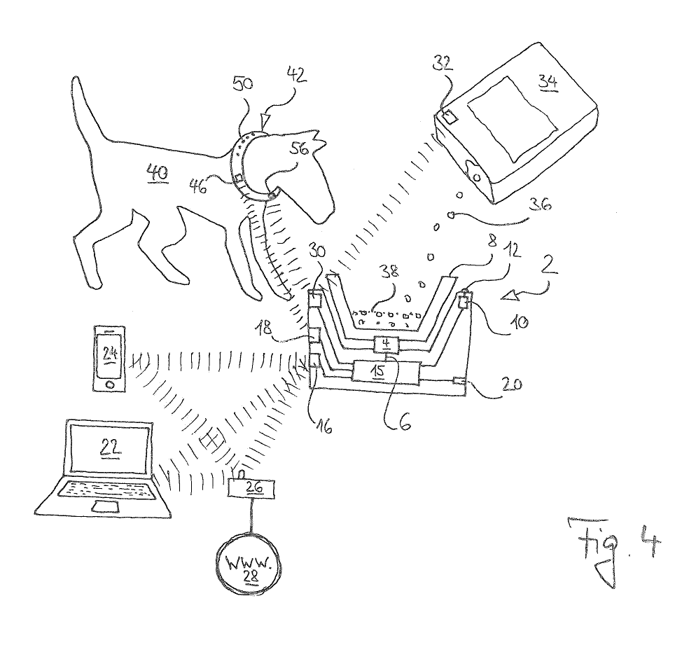

FIG. 4 shows a diagram illustrating a system according to the invention comprising a food bowl, collar, EDP devices and data connections.

FIGS. 1, 2 and 4 show a food bowl 2 for a domestic animal (not shown), in particular for a dog, with an electronic balance 4 which has a data output 6 (FIG. 4) and is designed to measure the weight in the bowl receptacle 8 and to transmit said weight to the data output as an electronic weight signal.

The food bowl 2 comprises an electronic display device 10 which is connected to the data output of the balance by means of a data connection, and is designed to change its display 12 in the form of a series of LEDs 14 as a function of the weight signal. The display device makes it possible to measure out the portion of a daily food requirement.

An EDP device 15 and data outputs in the form of a WLAN module 16 and a Bluetooth module 18 and a USB cable interface 20 are connected to the data output 6 of the balance 4 in addition to the display in the food bowl according to the invention. These data outputs may be connected to electronic computers 22, 24 and to an internet router 26 by means of a data connection, for various purposes, some of which are explained by way of example below. FIG. 4 shows a system designed in this manner. The bowl has a power supply cable 27 to supply mains power.

The computers 22, 24 (with correspondingly programmed and programmable software and wiring and operating hardware; not illustrated) and the router 26 are separate devices from the food bowl 2 and are “connected” by WLAN 16, or in other words wirelessly. One of the computers is a portable PC, a notebook 22 and one is a smartphone 24.

These computers 15, 22, 24 for the food bowl 4 are amongst other things designed by software, or by apps in the case of the separate computers 22, 24, to add up the weight signals in their memories (not shown) and to generate a trigger signal when a programmable limit value is reached.

The trigger signal may, for example, initiate a warning signal (for example one of the LEDs 14 on the bowl 2 and on the computer 22, 24) when a programmed filling quantity and/or daily ration is reached. To this end the computer 15, 22, 24 is able to process and save the weight signals, in particular also in a time-correlated manner, in order to establish, in connection with the daily food ration, whether the next day may possibly already have started if the limit value is exceeded and whether the additional food quantity therefore possibly belongs to the next day's ration. However, another function of the trigger signal is that it then places an order for a new supply of food (not shown) over the internet 28 via an online shop when the totalised food weight indicates that the existing food supply is running out.

The food bowl 2 also comprises an RFID sensor 30 for this function, said sensor being designed to initiate specific computer operations by detecting a specific RFID tag 32—in this case specifically on a food sack 34. The totalising memory in the computer 15, 22, 24 may initially be set to zero by a corresponding program, for example, before a new food pack 34 is opened. If food 36 is poured into the bowl 2 from this pack 34 with the RFID tag 32, the RFID sensor 30 “detects” this pack 34, weighs the amount of food 38 that has been poured out and saves this figure in the totalising memory in the computer 15, 22, 24: the pack is emptied by this amount. If something else is poured into the animal's bowl 2 in the meantime, the balance 4 according to the invention also weighs this item (and is also able to display this weight on the display of the separate computer 22, 24), but because the RFID tag 32 on the pack 34 is missing, this weight is not added to the totalising memory used to assess the pack filling level (but is probably added to at least one totalising memory recording the animal's eating behaviour). Only when food is again poured into the bowl 2 from this pack 34 with the RFID tag 32 does the RFID sensor 30 detect this pack 34 again, weigh the amount of food 38 that has been poured out and add this figure to the totalising memory. If a limit value in the totalising memory is exceeded, this means that the remaining food in the pack is less than its initial contents (the pack contents on purchase) minus the amount added to the totalising memory—and the computer 15, 22, 24 (which is programmed accordingly) is able to initiate an order for a new food pack and delivery of said pack (automatically, even without any further action on the part of the user).

The RFID sensor 30 on the food bowl 2 is not only able to initiate weighing and/or totalising actions, but may also be used to program the limit value to initiate the order. If specific different tags are programmed to specific different pack food weights in the program in the computer 15, 22, 24, the program may set a limit value adjusted to this pack weight for placing the order when it first detects an RFID tag.

Another function of the food bowl 2 is that it is able to take into account the activity of the animal 40 when feeding using the bowl. The integral EDP device 15 and separate computers 22, 24 are also used for this purpose. The integral EDP device 15 is designed to receive data from a collar 42 for a domestic animal, in particular for a dog 40. The collar 42 (also see FIG. 3) accordingly has a Bluetooth data transmitting device 46 and an “activity sensor” (not illustrated) on a printed circuit board 44. It also has an activity data memory (not illustrated).

The computers 15, 22, 24 are thus designed to receive electronic activity data from the collar 42 via Bluetooth 18. The EDP device is therefore able to change the display 12 on the bowl 2 (and on the displays on the separate computers 22, 24) as a function of the activity data and to evaluate the data on the displays on the separate computers 22, 24 by statistical and time-related means and to process said data in graphical form. However, the computers 15, 22, 24 are also programmed to calculate a required food portion weight based on the activity data and programmed and programmable parameters (in particular relating to the domestic animal, such as, for example, the type of animal, breed, weight, gender or age). As described in the introduction, there is a great deal of information about the relationship between food requirements and previous food consumption as a function of activity, and this relationship (less food is required for less activity in qualitative terms) can be taken into account in the calculation by different quantities. The EDP device 15 may in particular then transmit this required food portion weight as an electronic “requirement signal” to the display device 10 on the bowl 2 (and for display on the computer display in the form of an app).

The display device 10 is accordingly designed to also change its display as a function of the requirement signal. The display device 10 thus does not show the weight in the bowl receptacle 8 as a figure, but as a proportion of the calculated required food portion weight. For this purpose, in the illustrated example it is sufficient to have a row 12 of two-colour LEDs which first display the calculated required food weight for the animal for this portion in a first colour (required food portion weight)—with the full LED row 12 as “100%”—and then display the weight of the food portion poured into the bowl (measured by the integral balance 4 in the bowl 2) in relation to the first weight in a second colour.

A corresponding display is located on the collar 42: here a display device 50 shows the activity of the animal 40 as a proportion of a programmed activity requirement for the animal (possibly even calculated based on food consumption and transmitted to the electronic system in the collar by Bluetooth). For this purpose, in the illustrated example it is once again sufficient to have the row 50 of two-colour LEDs on the collar 42, said row first displaying the animal's required activity in a first colour—with the full LED row 50 as “100%”—and then displaying the animal's actual activity (measured by the activity sensor on the collar 42) in relation to the first figure in a second colour. To ensure that the display 50 on the collar remains clearly visible on top of the collar while the animal is wearing it, the collar has an integral weight 54 on the opposite side of its circumference (i.e. carried at the bottom).

The RFID sensor 30 on the bowl 2 has another function, namely to detect the animal 40 in its vicinity from an RFID tag 56 on its collar 42. This can be taken into account by the computers 15, 22, 24 when calculating and assessing food consumption. By programming the computers 15, 22, 24 accordingly, the RFID sensor is designed to influence the way in which food consumption is calculated and the consumption signal is saved by detecting the RFID tag on the collar 42—specifically to prevent the EDP device processing the food consumed by a different animal than the animal wearing the collar, if the other animal just happens to eat from the same bowl 2.

Similarly, the RFID sensor 30 in the bowl 2 may also initiate reception of activity data from the collar 42 and display and changes in the display, but only if the animal 40 wearing the collar 42 is detected at the bowl 2.

1. A food bowl for a domestic animal, the bowl comprising an electronic balance which has a data output and measures the weight in the bowl and transmits said weight to the data output as an electronic weight signal.

2. The food bowl according to claim 1, wherein the data output is connected to an electronic computer, an internet router, or both, by means of a data connection, or wherein the data output is designed for such a data connection.

3. The food bowl according to claim 2, wherein the computer adds up the weight signals and generates a trigger signal on reaching a programmable limit value.

4. The food bowl according to claim 3, further comprising an RFID sensor which initiates the measurement adding-up process, or both, and/or programs the limit value by detecting a specific RFID tag.

5. The food bowl according to claim 1, further comprising an electronic display device which is connected to the data output of the balance by means of a data connection, and the display device changes its display as a function of the weight signal.

6. The food bowl according to claim 5, further comprising a programmable electronic data processing (EDP) device, having a wireless data receiving device which:
receives, via a collar equipped with an activity sensor having an activity data memory and a radio data transmitting device, electronic activity data from said activity data memory;
calculates a required food portion weight from the activity data and programmed parameters; and
transmits said weight as an electronic requirement signal to the display device, said display device changing its display as a function of the requirement signal.

7. The food bowl according to claim 6, wherein the display device displays the weight in the bowl as a proportion of the calculated required food portion weight.

8. The food bowl according to claim 6, wherein the EDP device is connected to the data output of the balance by a data connection, and the EDP device calculates the time-related food consumption from the weight signal and a time signal and saves the result as an electronic consumption signal in a consumption signal data memory.

9. The food bowl according to claim 6, further comprising an RFID sensor which, upon detecting a specific RFID tag on the collar, initiates the reception of activity data from the collar, the display, and/or a change in the display, and/or saves the consumption signal in a consumption signal data memory.

10. The food bowl according to claim 6, wherein:
the EDP device is a separate, portable electronic computing device equipped with a Bluetooth module as the data receiving device which interacts with the collar and with a WLAN module and/or Bluetooth module to create a data connection with the data output of the balance and/or a data connection with the display device; and
the EDP device displays measured calculated, input and/or processed data and signals on a display of the EDP device by means of an app.

11. The food bowl according to claim 1, wherein the bowl is for a dog.

12. The food bowl according to claim 4, wherein the RFID tag programs the limit value by detecting a specific RFID tag.

13. The food bowl according to claim 12, wherein the RFID tag is on a food pack.

14. The food bowl according to claim 6, wherein the programmable electronic data processing (EDP) device is a separate device from the food bowl.

15. The food bowl according to claim 10, wherein the electronic computing device is a computer, smartphone or tablet.
